(19) United States
(12) Patent Application Publication
(10) Pub. No.: US 2008/0221849 A1
(43) Pub. Date: Sep. 11, 2008

(54) Method, Apparatus And Computer Program Product For Creating Electric Circuit Models Of Semiconductor Circuits From Fabrication Process Parameters

(76) Inventors: Matthew Stephen Angyal, Stormville, NY (US); Ibrahim M. Elfadel, Ossining, NY (US); Yidnek Mekonnen, Champaign, IL (US)

Correspondence Address: HARRINGTON & SMITH, PC, 4 RESEARCH DRIVE, SHELTON, CT, 06484-6212, US

(21) Appl. No.: 11/684,124

(22) Filed: Mar. 9, 2007

(51) Int. Cl. G06F 17/50

(52) U.S. Cl. 703/14

(57) ABSTRACT

Disclosed herein are methods and apparatus that automatically generate an electric circuit model from process parameters used to specify a semiconductor fabrication procedure, wherein at least one of the process parameters is specified as a statistical distribution. The methods and apparatus convert the process parameters into an electric circuit model. The electric circuit model is specified in terms of electric parameters, wherein at least one of the electric parameters is specified in terms of a statistical distribution. The methods and apparatus thus allow a process engineer whose expertise may not extend to state-of-the-art circuit modeling to develop insight into the effect of process parameter selection on the performance of the resulting electric circuit. The resulting insight is further enhanced since at least one of the electric parameters is specified in terms of a statistical distribution.

### TECHNICAL FIELD

The present invention generally concerns modeling of semiconductor circuits and more particularly concerns the automated translation of fabrication process parameters used to specify a semiconductor fabrication process into an electric circuit model of the semiconductor circuit created by the semiconductor fabrication process.

### BACKGROUND

Semiconductor process engineers need to understand the impact of process tolerances on the electrical performance of semiconductor devices. The path from process data to electric data is very intricate and requires expert knowledge of circuit analysis. Since process engineers typically are concerned with developments in process technology, they often lack expert knowledge concerning circuit analysis. Furthermore, the semiconductor fabrication process itself is becoming very involved in advanced technologies, which further complicates the evaluation of electric parameters. The known solutions based on rules of thumb and analytical approximations are no longer accurate enough. Also, solutions based on geometric information rather than process information neglects the impact of correlations between geometric and process parameters.

Progress has been made in understanding the impact of interconnect structures on circuit performance. Such understanding is limited, though, because it deals only with geometric interconnect information and not with semiconductor process information. Furthermore, it is restricted to nominal geometric parameters and does not address the case when these parameters have statistical distributions as they do in practice. Progress has also been made in understanding the effect of the statistical distribution of geometric parameters on electric parameters, including their pairwise correlation, but such understanding still does not address the issue of the effect of semiconductor process parameters on electric circuit performance.

Those skilled in the art desire methods and apparatus that allow process engineers to develop an understanding of the effect of process parameters on electric circuit performance. Those skilled in the art particularly desire methods and apparatus that allow process engineers to develop an understanding of the expected statistical distribution of electric parameters resulting from a semiconductor fabrication process. This is particularly important because various applications for integrated circuits resulting from a semiconductor fabrication process may exhibit widely varying tolerances to electric parameters exhibited by the integrated circuits. For example, if an application for an integrated circuit requires that electric parameters exhibited by the integrated circuit fall within relatively narrow statistical distributions, a process engineer would like to know before expending time and expense in actually fabricating the integrated circuit whether a collection of process parameters specifying a process for making the integrated circuit will result in a suitable device. Likewise, if an application for an integrated circuit is relatively tolerant of electric parameter variation, a process engineer would like to understand how the relatively loose tolerances of the application can be translated into a process for making the integrated circuit that is not unduly precise given the application. Precision often translates into expense, and if precision is both expensive and unnecessary, then a process engineer would be interested in developing an understanding of how process parameters can be relaxed while still meeting the needs of the application.

### SUMMARY OF THE INVENTION

The foregoing and other problems are overcome, and other advantages are realized, in accordance with the following embodiments of the invention.

A first embodiment of the invention is a method. In a step of the method, a computer interface is established. The computer interface is configured to accept process parameters for specifying at least one step in a semiconductor fabrication process. The computer interface permits a user to specify at least one of the process parameters as a statistical distribution. In another step of the method, the computer interface receives process parameters entered using the graphical user interface, wherein at least one of the process parameters is specified as a statistical distribution. In a further step of the method, digital processing apparatus converts the process parameters into an electric circuit model comprised of electric parameters, wherein at least one of the electric parameters is specified as a statistical distribution.

A second embodiment of the invention is a computer program product comprising a computer readable memory medium tangibly embodying a computer readable program. The computer readable program is configured to perform operations when executed by digital process apparatus. In a first operation, the computer program, when executed, causes a graphical user interface to be displayed on a display device of a computer. The interactive graphical user interface is configured to allow a user to specify process parameters concerning at least one step in a semiconductor fabrication process. The interactive graphical user interface is further configured to allow at least one of the process parameters to be specified as a statistical distribution. In another operation, the computer program, when executed, receives process parameters entered using the graphical user interface, wherein at least one of the process parameters is specified as a statistical distribution. In a further operation, the computer program, when executed, generates an electric circuit model comprised of electric parameters, wherein at least one of the electric parameters is specified as a statistical distribution.

A third embodiment of the invention is a system comprising: at least one computer memory; a computer program stored in the at least one computer memory, the computer program configured to perform semiconductor fabrication modeling operations when executed by digital processing apparatus; and digital processing apparatus coupled to the at least one memory. When the computer program is executed by the digital processing apparatus the system is configured to perform operations. In a first operation, the system displays on a display device a graphical user interface for specifying process parameters associated with at least one step in a semiconductor fabrication process. At least one of the process parameters is specified as a statistical distribution. In another operation, the system receives process parameters entered using the graphical user interface, wherein at least one of the process parameters is specified as a statistical distribution. In a further operation, the system generates an electric circuit model comprised of electric parameters, wherein at least one of the electric parameters is specified as a statistical distribution.

A fourth embodiment of the invention is a method. In a step of the method, process parameters are received. The process parameters specify a semiconductor fabrication process, and at least one of the process parameters is specified as a statistical distribution. In a further step of the method, the process parameters are converted into an electric circuit model comprised of electric parameters. At least one of the electric parameters is specified as a statistical distribution.

In conclusion, the foregoing summary of the various embodiments of the present invention is exemplary and non-limiting. For example, one or ordinary skill in the art will understand that one or more aspects or steps from one embodiment can be combined with one or more aspects or steps from another embodiment to create a new embodiment within the scope of the present invention.

### BRIEF DESCRIPTION OF THE DRAWINGS

The foregoing and other aspects of these teachings are made more evident in the following Detailed Description of the Invention, when read in conjunction with the attached Drawing Figures, wherein:

FIGS. 1A-D depict in cross-sectional views the results of semiconductor fabrication steps that can be modeled in accordance with the invention;

FIG. 2 are graphical user interfaces configured in accordance with an embodiment of the invention;

FIG. 3 is a graphical user interface configured in accordance with an embodiment of the invention;

FIG. 4 is a graphical user interface depicting a geometric model of a circuit element in accordance with an embodiment of the invention;

FIGS. 5A-B are charts depicting a statistical distribution of a process parameter and a statistical distribution of an electric parameter derived from the process parameter in accordance with an embodiment of the invention;

FIG. 6 is a flowchart depicting functional aspects of an apparatus operating in accordance with an embodiment of the invention;

FIG. 7 is a graphical user interface configured in accordance with an embodiment of the invention;

FIG. 8 is a chart depicting a statistical distribution of an electric circuit parameter derived from process parameters specified in terms of statistical distributions, all in accordance with an embodiment of the invention;

FIG. 9 is a chart depicting variations in expected values of an electric circuit parameter resulting from variations in two process parameters, all in accordance with an embodiment of the invention;

FIG. 10 is a flowchart depicting a method operating in accordance with the invention; and

FIG. 11 is a flowchart depicting another method operating in accordance with the invention.

### DETAILED DESCRIPTION OF THE INVENTION

The invention teaches a method for evaluating the impact of semiconductor process parameters on the electric performance of semiconductor circuits such as, for example, circuit interconnects. In one embodiment, the invention directly links statistical distributions of the semiconductor process parameters of, for example, a multi-layered interconnect structure to statistical distributions of the electric parameters of the structure (e.g., capacitance and resistance). Process engineers who are not expert in the art of electrical analysis can readily use methods and apparatus of the invention to analyze the effect semiconductor process parameters have on electric parameters and to target the process parameters most responsible for loss of electrical performance in, for example, interconnect wiring structures. An embodiment of this invention has a graphical user interface adapted to the language used by semiconductor process engineers and a parallel processing feature that significantly speeds up the translation of the statistical distributions of process parameters into statistical distributions of electric parameters.

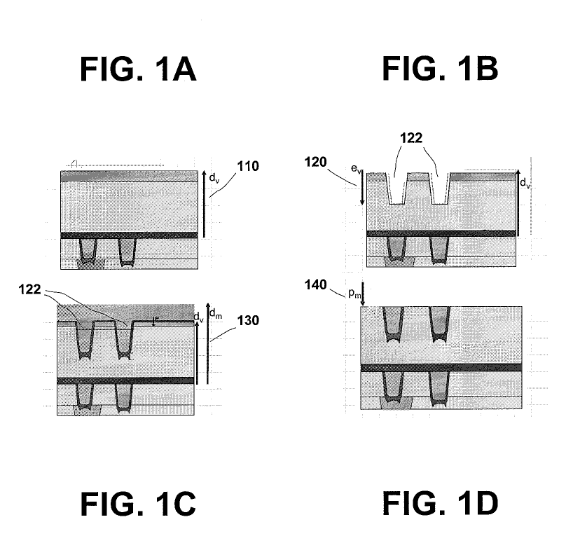

FIGS. 1A-D depict results of process steps in a semiconductor fabrication process known as a dual damascene process. This process comprises four steps: dielectric deposition the results of which are depicted in FIG. 1A, dielectric etching the results of which are depicted in FIG. 1B, metal deposition the results of which are depicted in FIG. 1C; and metal chemical-mechanical polishing (CMP) the results of which are depicted in FIG. 1D. A process parameter dᵥ 110 associated with the dielectric deposition step is shown graphically in FIG. 1A; a process parameter eᵥ 120 associated with the etching step is shown graphically in FIG. 1B, as well as vias 122 formed by the etching step; a process parameter dₘ associated with the metal deposition step is shown graphically in FIG. 1C; and a process parameter pₘ 140 associated with the polishing step is shown graphically in FIG. 1D. Mathematical relationships between primitive process parameters describing the above process steps and composite geometric variables used in electrical performance analysis can be derived. For example, one relationship expresses the via height (V) in terms of the height of the dielectric deposition and the depth of the dielectric etching:

V=dᵥ−eᵥ

Another relationship relates the metal height to the height of metal deposition, depth of metal polishing and height of the via below the metal layer in question:

H=dₘ−pₘ−(dᵥ−eᵥ)

Similar relationships exist for composite geometric variables associated with the remaining layers. This invention uses the process parameters as primitive parameters.

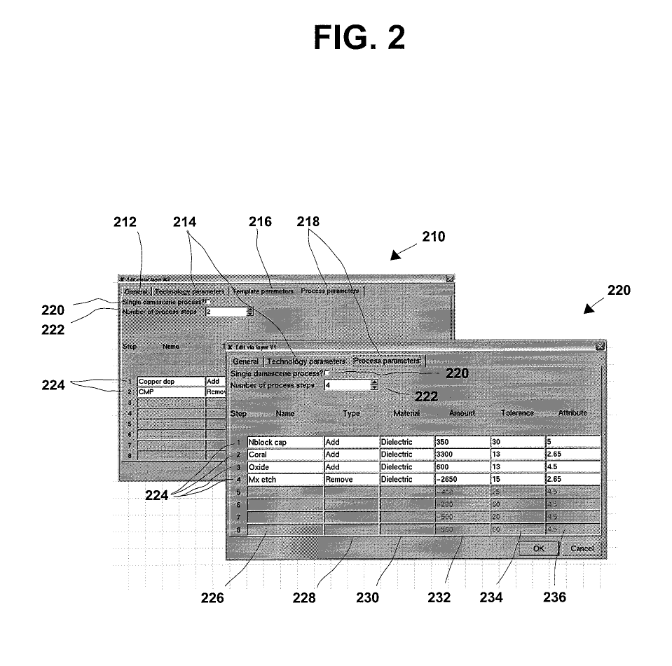

In an embodiment of the invention, exemplary graphical user interfaces 210, 220 as depicted in FIG. 2 are provided to allow a process engineer to specify process parameters that define a semiconductor fabrication process. As depicted in FIG. 2, the graphical user interfaces 210, 220 have tabs for selecting exactly which user interface a user desires to interact with. The tabs available in user interface 210 are “general” 212; “technology parameters” 214; “template parameters” 216; and “process parameters” 218. The tabs available in user interface 220 are “general” 212; “technology parameters” 214; and “process parameters” 218. The user interfaces for specifying the process parameters in accordance with the invention are selected by choosing tabs 218 entitled “process parameters”. The user interfaces displayed when tabs 218 are selected allow a user to specify process parameters for forming a metal layer as in 210 and a via layer as in 220. Each user interface has check-off box allowing a user to specify whether the semiconductor fabrication process corresponds to a damascene process. Each user interface also allows a user to specify the number of process steps needed to perform the particular procedure. In user interface 220 all process parameters used to specify process steps in a semiconductor fabrication process that forms a layer V1 in a semiconductor chip metal stack have been specified. Every step has a name specified in column 226, a type in column 228, a material in column 230, an amount in column 232, a tolerance in column 234 and an attribute in column 236. The “name” specified in column 226 refers to the step name in the process. It can be the industrial name of the material used in the step or any other name. The “type” specified in column 228 designates whether the step is an addition of material (deposition) or a subtraction of material (etching or polishing). The material specified in column 230 can be either a dielectric (coral, oxide, etc.) or a metal (copper, aluminum, etc.). The amount specified in column 232 is the quantity of material, added or subtracted, expressed in height or depth of addition or subtraction, respectively. The tolerance specified in column 234 is the 3-sigma uncertainty on the amount of material expressed as a percentage of the nominal value entered in the “amount” field. Finally, the attribute specified in column 236 is a physical property of the material such as the dielectric constant of the dielectric or the resistivity of the metal. The process engineer is free to edit and save the values entered in these fields of the graphical user interface. This invention therefore allows the process engineer to pose “what if” questions to the computer system embodying this invention. These “what if” questions will be based on the process parameters the semiconductor process engineer is familiar with rather than the composite geometric parameters familiar to circuit designers.

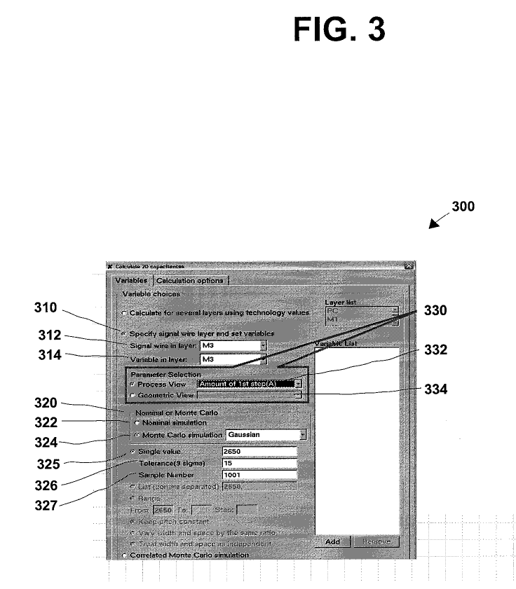

In an embodiment of the invention, the semiconductor process engineer can request an electric performance analysis from the computer program using another graphical user interface 300 as depicted in FIG. 3. In the boxes associated with portion 310 of graphical user interface 300, the engineer can specify the metal layer for which the analysis is requested as well as the view to be adopted in analysis (process or geometric). The user can also specify the layer to which the process variable under consideration belongs using entry boxes 302, 304. In the example of FIG. 3, the user has specified layer M3 as the analysis layer as well as the variable layer, the variable being the amount of the first step in metal layer M3, which is a metal deposition. Furthermore, in portion 320 the user can choose between a nominal analysis 322 or a statistical analysis 324 using the Monte Carlo method. When the latter is used, the statistical distribution of the process parameter (uniform, Gaussian, etc.) should be given in the associated box. Other parameters that can be entered are the nominal value 325, the 3-sigma tolerance 326, and the number of samples 327 to be used in the Monte Carlo analysis. Advantageously, none of the parameters entered by the process engineer requires any specialized knowledge or skill outside that of the semiconductor process engineers.

The graphical user interface 300 also has a portion 330 for specifying views to assist in parameter selection. Process view is selected with radio button 332. In the process view, all parameters, both design and process parameters are shown. Geometric view is selected with radio button 334. In geometric views only geometric parameters are shown.

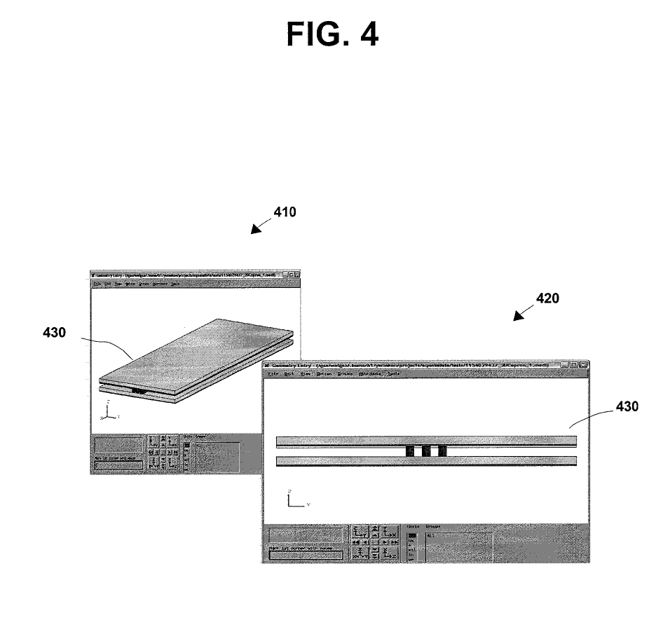

Once the user enters the parameters, the computer program maps the process parameters onto composite geometric parameters such as metal height and via height. Then it generates the geometric configurations from which electric parameters such as the resistance and capacitance of the metal structures are computed. Graphical user interfaces 410, 420 depicting a geometric configuration used for the calculation of capacitance are shown in FIG. 4. It represents what is known in the art of electrical analysis as a centered-wire structure 430 enclosed between two metal planes. The centered-wire structure is shown in perspective and cross-sectional views in 410 and 420, respectively. For each process parameter sample, the program generates such a structure and then calculates the total capacitance of the center wire using a field solver similar to that used in the prior art.

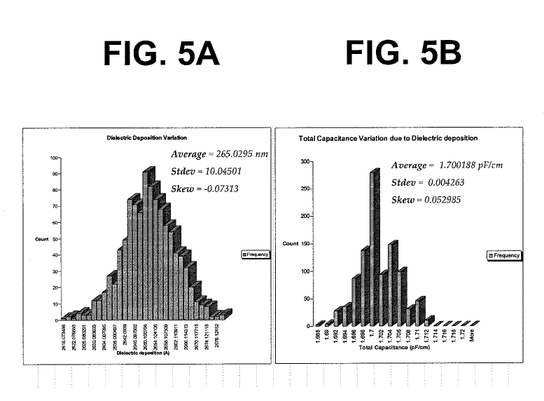

The result of all the capacitance calculations for all the samples is displayed in FIGS. 5A and 5B. In FIG. 5A, a histogram of the process variable statistical distribution is plotted (a dielectric deposition in this example). Such statistical values for the capacitance distribution as average, standard deviation and skew can also be output for the benefit of the process engineer. Outputs are not limited to capacitance distributions but can also include other electric parameters such as resistance, RC products and lateral capacitances. FIG. 5B depicts the electric parameter as a statistical distribution, illustrating the effect of the process parameter variation on the electric parameter.

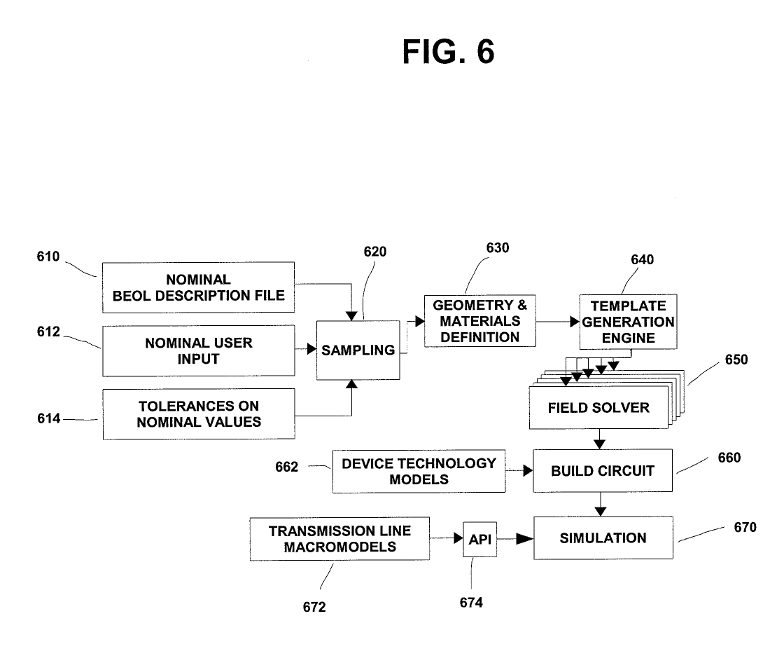

A feature of this embodiment is parallel processing capability. Statistical sampling methods such as Monte Carlo techniques are computationally intensive and so require excessive execution time when run sequentially. It is an advantage of the present invention that Monte Carlo statistical analysis can be run in parallel on clusters of sequential computing machines. FIG. 6 is the flowchart of the electrical analysis method, and illustrates the features and functions that would be implemented and performed by a digital processing apparatus operating in accordance with the invention. The field solver is the bottleneck of the computation, and so it is the most advantageous step for the parallel processing feature of this invention. Elements 610, 612 and 614 correspond to parameter specification operations. When specifying process parameters, in one embodiment of the invention the system queries a user what type of circuit that will be modeled. The system retrieves a file 610 that describes in terms of process parameters a structure that can be formed by a fabrication process. The user then provides at 612 nominal values for the process parameters and at 614 tolerances on the nominal values. Next, at 620, the system performs sampling operations for selected process parameters. Then, at 630, the system generates geometry and materials definitions. Next, at 640 a template generation engine generates templates for the structure, and a field solver 650 solves for electric parameters. Then, at 660, a circuit is constructed, using device technology models. Next, simulations are performed at 670 using transmission line macromodels 672 and API 674.

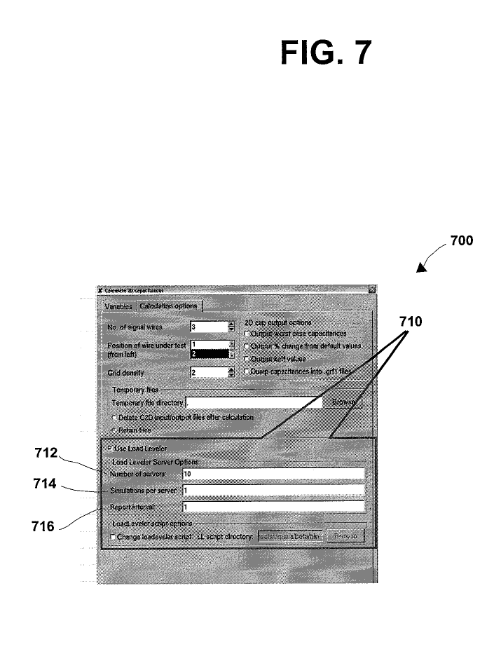

Another advantage of this invention is a parallel processing feature that allows semiconductor engineers not skilled in the art of parallel computing to perform complex simulations. FIG. 7 is an illustration of a graphical user interface 700 implementing the parallel processing feature. The graphical user interface 710 has an input field 712 where the user enters the number of servers to be used; an input field 714 for specifying how many simulations are to be done by each server; and a “Report interval” input field 716. The “report interval” refers to the frequency at which reports about simulation status are to be broadcast back to the client program. A report interval of 1 means that reports will be sent at the end of every simulation.

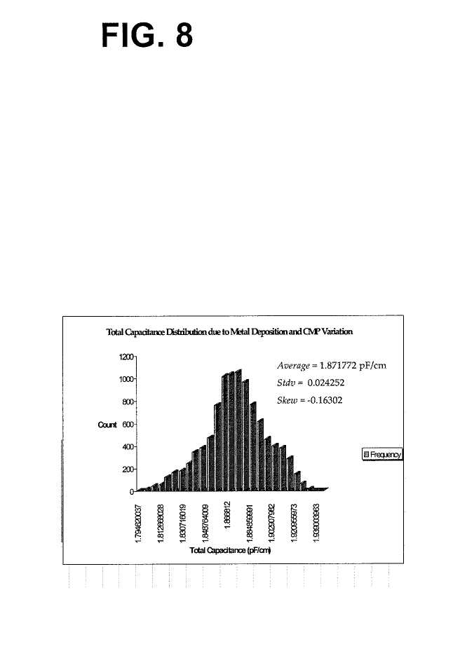

The parallel processing feature enables another advantage of this invention, namely the advantage that the process engineer can evaluate the statistical impact of the variations of two or more process parameters on electric parameters. An important improvement of this invention with respect to the teachings of the prior art is that the primitive process parameters are uncorrelated and therefore correlation information of the type required by composite geometric parameters is not needed anymore. FIG. 8 displays a histogram of statistical capacitance distribution resulting from the statistical variations of two process parameters, namely, metal deposition and chemical-mechanical polishing (CMP). The number of samples used for each parameter was 100; the tolerance specified for deposition was 15%; and the tolerance specified for polishing was 60%. In performing the simulation, 10,000 runs were executed, the simulation time for series corresponded to 10 hours; and the simulation time for parallel was 45 minutes.

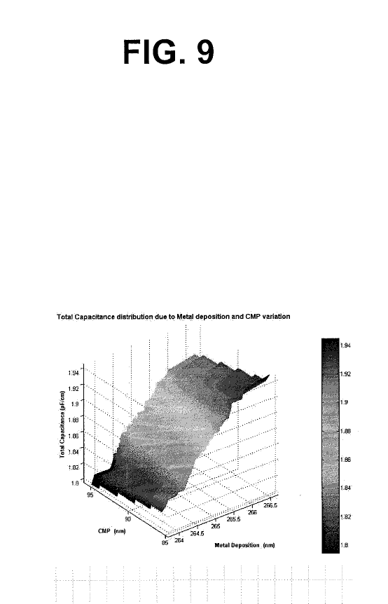

Yet another advantage of the present invention is the visualization feature of the electric parameter as a function of the process parameters. FIG. 9 shows the surface response of total capacitance as a function of the variations of two process parameters: metal deposition and CMP.

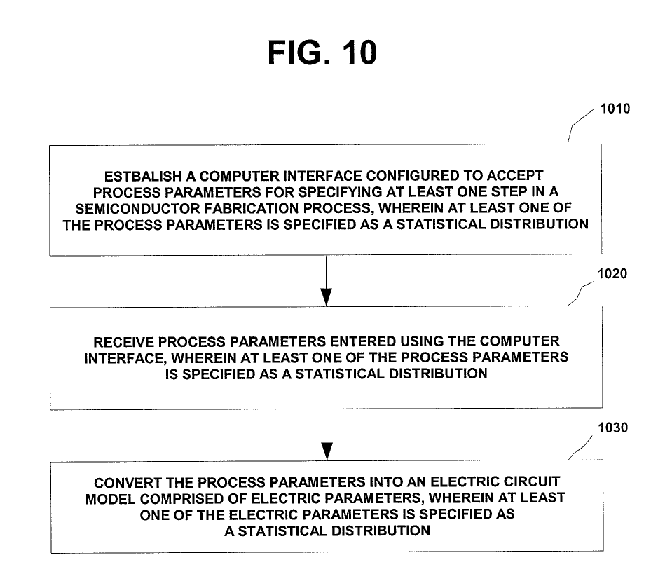

FIG. 10 is a flowchart depicting a method in accordance with an embodiment of the invention. At step 1010, a computer interface is established to accept process parameters for specifying at least one step in a semiconductor fabrication process, wherein at least one of the process parameters is specified as a statistical distribution. Depending on the implementation, the computer interface can be a machine-to-machine interface, or a man-machine interface (such as, for example, an interactive graphical user interface as described previously). Next, at step 1020, process parameters are received from the computer interface, wherein at least one of the process parameters is specified as a statistical distribution. Then, at step 1030, the process parameters are converted into an electric circuit model comprised of electric parameters, wherein at least one of the electric parameters is specified as a statistical distribution.

In various embodiments of the invention, the process parameters concern at least a deposition step; an etching step; or a polishing step.

The process parameters are used to create an electric circuit model in various ways. In one embodiment of the invention, the process parameters are used to derive composite geometric parameters. The composite geometric parameters are then used to generate a geometric model of the electric circuit. The geometric model of the electric circuit is then used to calculate the electric parameters. Field solvers can be used to calculate the electric parameters.

In a further embodiment of the method depicted in FIG. 10 a sampling procedure for the process parameters may be used when converting the process parameters into an electric circuit model. When using a sampling procedure, electric parameters may be calculated for each sample. A histogram may be used to generate a statistical characteristic of an electric parameter such as a mean of a distribution; a standard deviation of a distribution; or a skew of a distribution. In one exemplary embodiment, the sampling procedure comprises a Monte Carlo sampling procedure.

When using a sampling procedure, in an embodiment of the invention the sampling procedure may be run in parallel on a cluster of sequential machines. In embodiments of the invention allowing the sampling procedure to be run in parallel on a cluster of sequential machines, a graphical user interface may be provided to control the sampling procedure. Although there are many possible implementations of a graphical user interface in accordance with this aspect of the invention, one exemplary embodiment of a graphical user interface comprises input fields for specifying: the number of sequential machines that will be used to perform the simulation; the number of simulations to be performed by each sequential machine; and the report interval for each sequential machine involved in the simulation.

In embodiments of the method depicted in FIG. 10 where the computer interface comprises an interactive graphical user interface, the computer graphical user interface will comprise a plurality of input fields. In one exemplary embodiment the interface comprises at least: an input field for specifying number of process steps; and input fields for specifying name, type, material, amount, tolerance and attribute of each step.

Embodiments of the method depicted in FIG. 10 also provide a user interface that allows a user to further define geometric configurations. Such a user interface comprises input fields for specifying: a layer where the geometric configuration is placed; a layer where the process variable is placed; a name of a process parameter; whether a Monte Carlo simulation is desired; whether a process or geometric view is desired; a nominal value, tolerance and number of samples of a particular process parameter; and the nature of a statistical distribution for a particular process parameter.

In still further embodiments, converting the process parameters into an electric circuit model further comprises outputting the statistical distribution of the at least one electric parameter as a histogram or as a response surface.

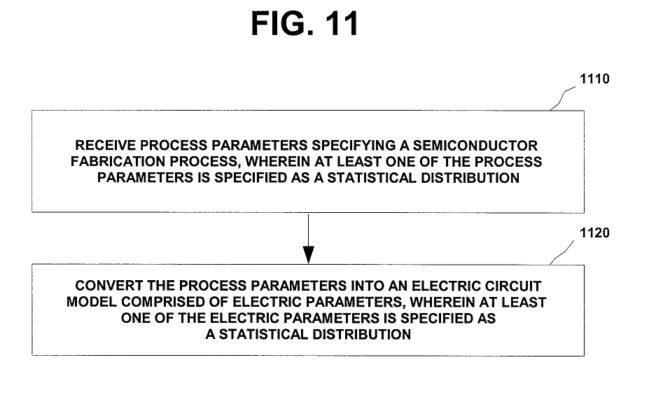

FIG. 11 is a flowchart depicting another method operating in accordance with the invention. At step 1110, process parameters are received specifying a semiconductor fabrication process, wherein at least one of the process parameters is specified as a statistical distribution. Then, at step 1120, the process parameters are converted into an electric circuit model, wherein at least one of the electrical parameters is specified as a statistical distribution. One of ordinary skill in the art will understand that aspects of various embodiments described with respect to FIG. 10 can be practiced in combination with the method depicted in FIG. 11.

One of ordinary skill in the art will understand that methods depicted and described herein can be embodied in a computer program storable in a tangible computer-readable memory medium or signal bearing medium. Instructions embodied in the tangible computer-readable memory or signal-bearing medium perform the steps of the methods when executed. Tangible computer-readable memory media include, but are not limited to, hard drives, CD- or DVD ROM, flash memory storage devices or in a RAM memory of a computer system.

In addition, apparatus can be configured to perform operations corresponding to those depicted and described with respect to FIGS. 10-11. Such apparatus would comprise a computer readable memory storing a computer program configured to cause the apparatus to perform operations similar to those depicted in FIGS. 10-11 when executed and digital processing apparatus to perform the operations.

Thus it is seen that the foregoing description has provided by way of exemplary and non-limiting examples a full and informative description of the best apparatus and methods presently contemplated by the inventors for creating electric circuit models of semiconductor circuits from process parameters used to specify fabrication processes used to form the semiconductor circuits. One skilled in the art will appreciate that the various embodiments described herein can be practiced individually; in combination with one or more other embodiments described herein; or in combination with methods and apparatus differing from those described herein. Further, one skilled in the art will appreciate that the present invention can be practiced by other than the described embodiments; that these described embodiments are presented for the purposes of illustration and not of limitation; and that the present invention is therefore limited only by the claims which follow.

1. A method comprising:
establishing a computer interface configured to accept process parameters for specifying at least one step in a semiconductor fabrication process, wherein at least one of the process parameters is specified as a statistical distribution;
receiving process parameters entered using the computer interface, wherein at least one of the process parameters is specified as a statistical distribution; and
converting the process parameters into an electric circuit model comprised of electric parameters, wherein at least one of the electric parameters is specified as a statistical distribution.

2. The method of claim 1 wherein establishing a computer interface further comprises displaying an interactive graphical user interface, wherein the interactive graphical user interface is configured to permit interactive specification of the process parameters, wherein at least one of the process parameters is specified as a statistical distribution.

3. The method of claim 1 wherein the semiconductor process parameters comprise at least one selected from the group comprising a deposition step; an etching step; and a polishing step.

4. The method of claim 1 wherein converting the process parameters into an electric circuit model further comprises using the process parameters to derive composite geometric parameters.

5. The method of claim 4 wherein converting the process parameters into an electric circuit model further comprises using the composite geometric parameters to generate a geometric model of the electric circuit.

6. The method of claim 5 wherein converting the process parameters into an electric circuit model further comprises using the geometric model of the electric circuit to calculate the electric parameters.

7. The method of claim 6 wherein converting the process parameters into an electric circuit model further comprises using field solvers to calculate the electric parameters.

8. The method of claim 1 wherein converting the process parameters into an electric circuit model comprised of electric parameters further comprises using a sampling procedure for the semiconductor process parameters.

9. The method of claim 8 wherein the sampling procedure comprises calculation of the electric parameters for each sample.

10. The method of claim 9 wherein a histogram is used to generate at least one statistical characteristic selected from the group of: mean of a distribution; standard deviation of a distribution; and skew of a distribution.

11. The method of claim 8 wherein the sampling procedure comprises a Monte Carlo sampling procedure.

12. The method of claim 11 wherein the Monte Carlo sampling procedure is run in parallel on a cluster of sequential machines.

13. The method of claim 12 further comprising controlling the Monte Carlo sampling procedure by using a graphical user interface, wherein the graphical user interface has an input field for specifying a number of sequential machines used to perform the simulation; an input field for specifying a number of simulations to be performed by each sequential machine; and an input field for specifying a report interval for each sequential machine.

14. The method of claim 1 wherein the computer interface comprises an interactive graphical user interface comprising at least: an input field for specifying number of process steps; and input fields for specifying name, type, material, amount, tolerance and attribute of each process step.

15. The method of claim 5, wherein the geometric configurations are further defined by a graphical user interface comprising input fields for specifying: a layer where the geometric configuration is placed; a layer where the process variable is placed; a name of a process parameter; whether a Monte Carlo simulation is desired; whether a process or geometric view is desired; a nominal value, tolerance and number of samples of a particular process parameter; a nature of statistical distribution for a particular process parameter.

16. The method of claim 1 wherein converting the process parameters into an electric circuit model further comprises outputting the statistical distribution of the at least one electric parameter as a histogram.

17. The method of claim 1 wherein converting the process parameters into an electric circuit model further comprises outputting the statistical distribution of the at least one electric parameter as a response surface.

18. A computer program product comprising a computer readable memory medium tangibly embodying a computer readable program, the computer readable program executable by digital processing apparatus, the computer readable program, when executed by digital processing apparatus, configured to display on a display device of a computer an interactive graphical user interface for specifying process parameters concerning at least one step in a semiconductor fabrication process, wherein at least one of the process parameters is specified as a statistical distribution; to receive process parameters entered using the graphical user interface, wherein at least one of the process parameters is specified as a statistical distribution; and to generate an electric circuit model comprises of electric parameters, wherein at least one of the electric parameters is specified as a statistical distribution.

19. A system comprising:
at least one computer memory;
a computer program stored in the at least one computer memory, the computer program configured to perform semiconductor fabrication modeling operations when executed by digital processing apparatus;
digital processing apparatus coupled to the at least one memory, wherein when the computer program is executed by the digital processing apparatus the system is configured to display on a display device a graphical user interface for specifying process parameters associated with at least one step in a semiconductor fabrication process, wherein at least one the process parameters is specified as a statistical distribution; to receive process parameters entered using the graphical user interface, wherein at least one of the process parameters is specified as a statistical distribution; and to generate an electric circuit model comprised of electric parameters, wherein at least one of the electric parameters is specified as a statistical distribution.
